(19) United States
(12) Patent Application Publication
(10) Pub. No.: US 2008/0044534 A1
(43) Pub. Date: Feb. 21, 2008

(54) Method for Making a Masa Based Dough for Use in a Single Mold Form Fryer

(76) Inventors: Sheri Lynn Baker, Dallas, TX (US); Ajay Rajeshwar Bhaskar, Allen, TX (US); John Mampra Mathew, Plano, TX (US); Renu Mathew, Plano, TX (US); Kevin Matthew Trick, Dallas, TX (US)

Correspondence Address: Carstens, Yee & Cahoon, L.L.P., P.O. Box 802334, Dallas, TX, 75380, US

(21) Appl. No.: 11/843,761

(22) Filed: Aug. 23, 2007

Related U.S. Application Data
(62) Division of application No. 10/848,881, filed on May 19, 2004, now abandoned.

(51) Int. Cl. A23L 1/164

(52) U.S. Cl. 426/439

(57) ABSTRACT

A method of making a masa-based dough for use in a single mold form fryer. The invention is an improved process of making a buoyant, low density, low moisture content dough that is easily sheetable and results in a fried tortilla chip-like product with a similar texture of traditional tortilla chips. Starch is added to corn masa dough to help control moisture release during frying. The high shear mixing of the dough entrains air through nuclei formation making the dough more buoyant, and results in a smaller particle size of the dough increasing the uniformity of moisture distribution. The uniformity of moisture distribution provides more uniform buoyancy of the masa-based dough as it travels through a single mold form fryer.

### BACKGROUND OF THE INVENTION

1. Technical Field

The present invention relates to a method of making dough for a masa-based snack food. More particularly, the invention relates to a method of making dough for a masa-based snack food that can be used in a single mold form fryer.

2. Description of Related Art

Snack pieces are known to be prepared with the use of fryers. Generally, snack pieces such as fabricated potato crisps are formed from dough and are sheeted and cut into discrete pieces (pre-forms) for treatment. Treatment involves cooking the pre-forms in a fryer to produce cooked snack pieces. There are several types of prior art fryers typically used in the snack food industry for frying snack food products that require relatively even frying on all sides of the product. In general, these fryers cook product as it passes through a stream of hot oil.

Particularly with potato crisps and tortilla chips, a form fryer is beneficial because pre-forms can be molded and cooked into a desired product shape. A form fryer is a fryer for producing snack pieces having generally two conveyors, an upper and a lower conveyor. On each conveyor are molds or surfaces designed to interact with the opposing conveyor's molds or surfaces. After pre-forms are placed in the fryer, the top mold or contact surface keeps the now cooking pre-form beneath the surface of the oil until the fryer exit.

FIG. 1 shows an example of a prior art form fryer. The fryer assembly 10 has a fryer housing 12 that contains conveyors for moving pre-forms there through. To maintain desired environmental conditions within the housing 12, steam or inert gas may be circulated through portions above and around oil within the fryer and is supplied through a port 14, although additional ports may be added as needed. A top belt 20 is disposed in a top portion of the fryer housing 12 and is supported and rotated by two rollers 22, 24. A bottom belt 30 is disposed beneath the top belt 20. The bottom belt 30 is a continuous loop belt and is supported and rotated by two rollers 32, 34. A fryer pan 50 containing a body of oil 52 is situated within the fryer housing 12 so that at least a portion of the top and bottom belts 20, 30, when adjacent to each other, are passed through the oil 52. Oil 52 is circulated through a fryer pan 50 from an oil inlet 54 to an oil outlet 56 by, for example, a pump (not shown). Oil may be maintained at a desired cooking temperature with steam that is jacketed around the fryer pan 50. Alternatively, the oil can be maintained at a desired cooking temperature by routing the oil through an external heat exchanger or by some other heating means known in the art.

For cooking, pre-forms are led towards the fryer by the bottom belt 30 starting at about the input-side roller 32. The pre-forms are then followed from above by the top belt 20 and led towards a point in the oil 52 where the bottom belt 30 comes into close proximity with the top belt 20. By at least this point, the pre-forms have made contact with at least one mold surface. While not depicted, molds are commonly placed on at least the exterior surface of the top belt 20 but may also be placed on the exterior surface of the bottom belt 30. Once the pre-forms are secured between the top and bottom belts 20, 30, which run substantially parallel to each other through the oil 52, they are introduced to the hot cooking oil 52 at an oil entry point 53. The pre-forms thereafter travel through the hot oil 52 in the oil pan 50 completely submerged until they emerge from the oil 52 at an oil exit point 55. A typical form fryer may be operated with an oil frying temperature between 240 to 400° F. Thereafter, the cooked snack pieces are transferred by the oil and conducted along the exit portion of the bottom belt 30 and are transferred to the next segment of the overall process at about the output-side roller 34 for seasoning, if desired, and packaging.

By using a form fryer such as the prior art example fryer assembly 10, snack foods, such as tortilla chips, are capable of being fabricated with a standard and desirable shape. The frying of individual pieces presents numerous difficulties such as wrinkling, folding, clumping, and sticking to cooking surfaces. With the use of a form fryer, as opposed to other types of frying, a number of these difficulties can be resolved.

Another desirable feature of molded snack pieces is that they can be made uniform in size and shape. With uniformity, the snack pieces can be packaged in a seated alignment. This allows for the packaging of snack product into a canister as opposed to being packed loosely in a bag. Canister packaging provides a degree of protection against breakage of the snack pieces while providing improved transportability of the snack pieces both in bulk and in individual canisters. Also, canisters can be sealed with a lid after opening to deter product degradation.

While dual mold form fryers resolve a significant number of problems in frying snack pieces, dual mold form fryers require a significant volume of oil. A large volume of equipment, including two conveyor belts, along with the food product to be fried, must pass through hot oil and remain submerged for a time sufficient to cook the product. In traditional form fryers, there must be enough oil to submerge two conveyor belts, at least one product mold, and the product to be cooked. A considerable amount of energy, and thus money, is required to heat, pump and maintain this large volume of oil.

In addition, there is significant expenditure associated with replacing oxidized oil with fresh oil. Because form fryers typically have at least one conveyor with surfaces that cycle between the air and oil, the equipment itself introduces oxygen to the oil. Oil in the system gradually becomes oxidized as it absorbs oxygen at the air/oil interface and from submerging conveyor material. Oil oxidation causes oil to go rancid over time, thus the oxidized oil in the system must be replaced with fresh oil periodically. It would therefore be advantageous to reduce the volume of submerged equipment without adversely affecting the performance of the fryer. If the volume of submerged equipment can be reduced, the opportunity for such equipment to introduce oxygen into the oil can be reduced, thus slowing oxidation and reducing costs associated with replacing oxidized oil with fresh oil. In addition, expenditures for heating, pumping, and maintaining the oil can also be reduced.

Another problem encountered with prior art form fryers is the difficulty of providing a bottom conveyor that can accommodate the evolving shape of cooking product. As the dough to be fried typically enters the fryer with one shape and exits with another, it is difficult to design a prior art bottom conveyor with product molds or receptacles that can accommodate the shapes of both pre-forms and cooked product.

One solution to the problems encountered with prior art double-mold form fryers is to use a single mold form fryer that substitutes separate bottom entrance and exit conveyers from the main bottom conveyer. Such a single mold form fryer is illustrated by pending U.S. patent application Ser. No. 10/347,993, assigned to the same assignee as of the present application. An embodiment of this single mold form fryer is shown in FIG. 2. However, while it is desirable to use a single mold form fryer, it has proven difficult to use a single mold form fryer for masa-based doughs.

One drawback with using a masa-based dough in a single mold form fryer is the required dwell time. The dwell time for a typical masa-based chip is in excess of forty seconds in a monolayer fryer. This long dwell time requires either a large fryer, or slower production rates, thus increasing expenses. In addition, longer dwell times decrease the oil turnover rate. As the oil turnover rate, or the amount of oil that is removed from the fryer by the product, decreases, then oil turnover time increases, lowering oil quality.

Another drawback to using a masa-based dough in a single mold form fryer is the requisite buoyancy for a pre-form to engage and continually mate with a top mold as the pre-form travels through the oil. For example, the specific gravity of oil in a fryer at a temperature between about 330 to 390 degrees Fahrenheit ranges from about 0.77 to about 0.84. The density of a typical prior art masa dough ranges from about 1.07 to about 1.14 grams per cubic centimeter before sheeting and about 1.30 to about 1.40 grams per cubic centimeter after sheeting. When such a dough is placed into oil in a fryer having a specific gravity lower than the density, the dough will initially sink.

Another problem encountered with prior art fryers is that masa-based dough typically comprises a moisture content of about 50 percent. With this moisture content, excess water in the dough will be converted into steam upon insertion into the fryer. The chip texture is disturbed as the moisture on the inside is converted into steam. This violent action not only deforms and distorts part of the chip, but it also causes the chip to stick to the mold as its buoyancy is increased. Once steam escapes from the snack food substrate the buoyancy of the chip is lessened and the chip does not have the requisite buoyancy driving force to take the shape of the mold. One solution to this problem may be to lower the moisture in the dough. However, dough machineability and sheet integrity are strongly dependent on the dough moisture. At low moistures the dough sheet is crumbly and the chips have poor shape integrity. The regrind from the cutter is crumbly and difficult to recycle. Further, the chips made from a low moisture dough tend to have a harder texture that results in undesirable grittiness and tooth packing.

Another solution to this problem may be to reduce the moisture content of the dough after the dough has been cut into its final shape. The dough could be sent through a toaster where the chips are baked for fifteen to thirty seconds at about 575° F. to about 600° F. This removes moisture from the chips. The chips could then be sent through an equilibrator to allow residual moisture to evaporate or migrate evenly. This could prevent blistering or puffing due to pockets of moisture forming and evaporating when the chips contact the frying oil. However, there are undesirable results that do not make this solution conducive to single mold form fryers. For example, after leaving the oven or toaster, the chips have increased stiffness. This is undesirable because some elasticity is required for the pre-form to engage, mate with, and take the shape of a mold on the top conveyor of the single mold form fryer. In addition to imparting stiffness in the pre-form, the toaster oven also potentially causes chip curl. A curled chip, because of its varying thickness, would also be unable to engage, mate with, and take the shape of the mold. Moreover, a toaster and equilibrator also adds unit operations and requiring more conveyor belt transfer points. More transfer points increases potential side-to-side and rotational chip movement. Too much movement can prevent the chip from acquiring the proper registration required to properly engage, mate with, and take the shape of the mold.

Therefore, a method for making a masa-based dough that can be used in a single mold form-frying device is desired. An improved dough should have the requisite properties for optimal texture, sheeting, dwell time, and buoyancy in the single mold form fryer. Use of such masa-based dough in a single mold form frying device should eliminate the bottom conveyor and instead have separate bottom entrance and bottom exit conveyors, leaving a reduced volume segment between the two bottom conveyors. By eliminating the bottom conveyor in the reduced volume segment, less oil would be needed within the fryer system, and money can be saved on oil heating, pumping, maintenance, and replacement.

### SUMMARY OF THE INVENTION

The present invention involves pre-hydrating and mixing a dry masa. Minor ingredients such as added starches, corn syrup solids, flavor enhancers, emulsifiers, color, and leavening agents are then added to make a flour. The flour is mixed and water is added to the mixed flour to make a dough. The dough is then mixed in a high shear mixer. This high shear mixing decreases the particle size of the dough, increases the uniformity of the moisture distribution within the dough, and entrains air in the dough.

Surprisingly, the uniform water distribution and smaller particle size provides for a low moisture content dough that is easily sheeted, and comprises a texture similar to prior art masa-based chips. The entrained air helps lower the dough density. Moreover, the dough made by the present invention has the added properties of greater buoyancy and a shorter dwell time than traditional, higher moisture content masa-based doughs. Thus, a masa-based dough that can be used in a single mold form fryer is provided by the instant invention.

The above, as well as additional features will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives, and advantages thereof, will be best understood by reference to the following detailed description of illustrative embodiments when read in conjunction with the accompanying drawings, wherein:

FIG. 1 is a schematic cross sectional view of a prior art form fryer with continuous top and bottom conveyors;

FIG. 2 is a schematic cross sectional view of a single mold form fryer;

FIG. 3 is a partial cross-sectional view of convexly shaped molds disposed on a top conveyer of a form fryer; and

FIG. 4 is a flow chart representation of one embodiment of the invention.

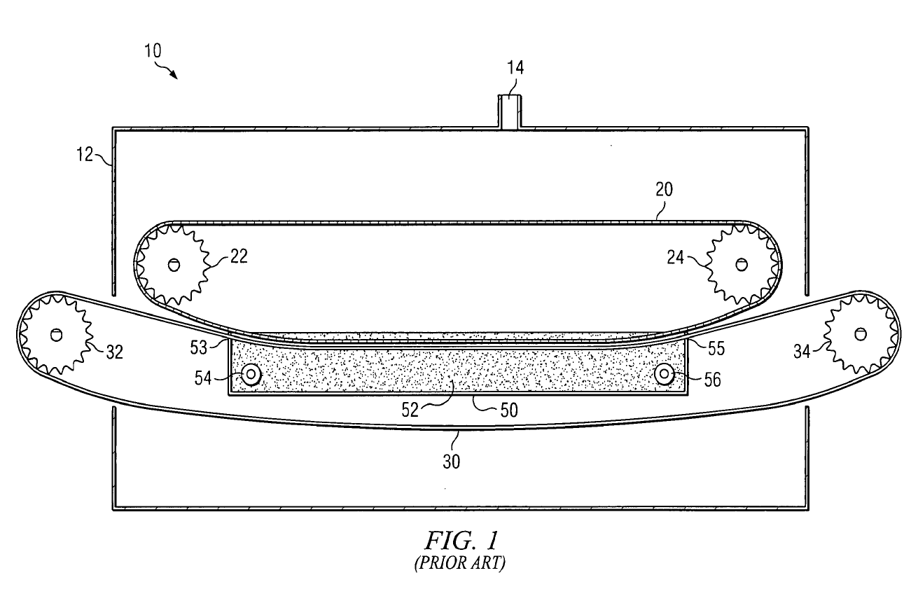

### DETAILED DESCRIPTION

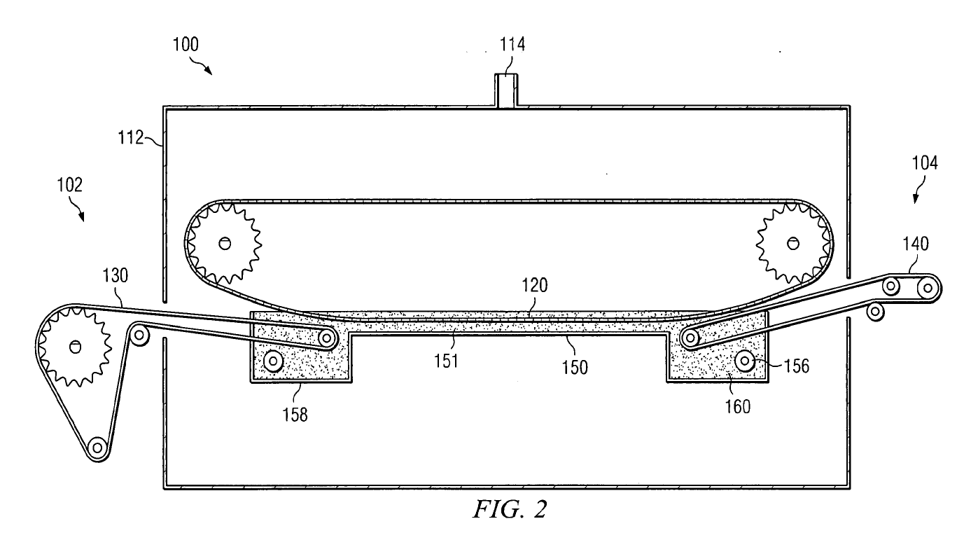

The instant invention provides a method for making a masa-based dough that can be used in the single mold form fryer shown in FIG. 2. FIG. 2 is a schematic cross sectional view of a single mold form fryer. A fryer assembly 100 receives snack products to be fried at an entrance area 102. After cooking, the snack products exit the fryer assembly 100 on an exit conveyer 140 at an exit area 104. Between the entrance area 102 and the exit area 104 is a fryer housing 112 having a port 114 for controlling the fryer environment above the cooking snack products. The top conveyer 120 of the single mold form fryer is disposed longitudinally within the fryer and is positioned above a fryer oil pan 150. Pre-forms are then delivered by a bottom entrance conveyer 130 into oil 151 within the fryer oil pan 150 for cooking. The pre-forms with proper buoyancy then rise up in the oil and dispose themselves against molding surfaces on the top conveyer 120.

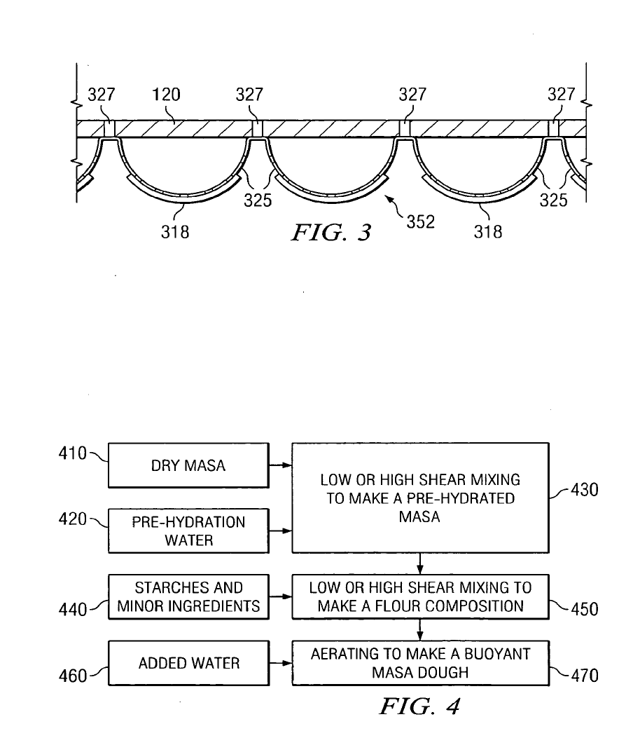

FIG. 3 is a partial cross-sectional view of convexly shaped molds disposed on a top conveyer of a form fryer. Where used in FIGS. 2 and 3, the same numerals designate the same or similar parts. As shown in FIG. 3, a plurality of molds 325 are disposed upon a top conveyor 120. Upward forces from the cooking oil 352 support the cooking snack pieces 318 in position against the surfaces of a plurality of molds 325. These molds 325 are retained by a plurality of supports 327 to the top conveyor 320. The top conveyor 320 and molds 325 may comprise an oil-pervious, chain-link structure of a durable material such as stainless steel or another type of metal, a ceramic, or a polymer-based material capable of withstanding exposure to hot oil. Alternatively, the top conveyor 320 may also comprise any food-grade, perforated, durable, but flexible material able to withstand frying oil temperatures. Further, each mold 325 is formed with a plurality of holes or channels to allow steam and other gases to rise and pass through or by to escape from the cooking oil 352. This is provided to remove gases released from cooking which would otherwise collect and dislodge snack pieces.

Referring back to FIG. 2, once the snack pieces are disposed against the top conveyor 120, the top conveyor 120 may be directed through a reduced oil volume segment within the fryer oil pan 150. The reduced volume segment cooks the snack pieces without having a continuous bottom conveyor passing there through. As no bottom conveyor is required in the reduced volume segment, considerable savings are possible in that less oil need be used in the fryer. With less oil to heat, pump, and maintain, oil processing and maintenance expenditures can be reduced. In addition, eliminating the bottom conveyor in the reduced volume segment decreases the amount of oil oxidation that occurs due to submerging equipment. This reduction in oil oxidation creates further savings by reducing oil replacement costs. In addition, because the dough formulation formed by the instant invention allows the masa-based pre-forms to be cooked with less dwell time, a smaller fryer and less oil are required.

The method of dough formulation of the present invention allows all the advantages of a single mold form fryer to be exploited for a masa-based dough. Using the dough formulation disclosed in Table 1 below along with the process disclosed in FIG. 4, the instant invention discloses a method for making a masa-based dough for use in a single mold form fryer.

TABLE 1
Ingredients for Dough for Single Mold Form Fryer

| | Formula Weight | |
|---|---|---|
| Ingredient | Percent | Range Percent |
| Corn Masa | 40 | 20-60 |
| Potato Starch (Pre-Gelatinized) | 16 | 0-50 |
| Modified Starch | 12 | 0-50 |
| Corn Syrup Solids | 4 | 0-10 |
| Flavor Enhancer | 2 | 0-5 |
| Emulsifier | 0.3 | 0-3 |
| Color | 0.1 | 0-2 |
| Added Water | 25.6 | 15-40 |
| Leavening Agent | 0 | 0-5 |

As indicated by the ranges given in Table 1 above, the dough can be made by excluding some of the ingredients. The ingredients that can be excluded are, for purposes of this invention, referred to as “minor ingredients” and comprises added starches, corn syrup solids, flavor enhancers, emulsifiers, colors, and leavening agents. Although the ranges given above indicate that different starches can be excluded, the dough, in one embodiment comprises at least one type of added starch. In an alternative embodiment, free starch (defined and discussed below) can be used in lieu of some or all added starches. The added starch used can be from the group consisting of modified starches, pre-gelatinized starches, native starches, pre-gelatinized modified starches, and mixtures thereof.

The lower moisture content of the dough of the present invention results in several benefits. First, a lower moisture content dough lowers the dough density and thus inherently raises the dough buoyancy. As dough buoyancy increases, the buoyancy driving force increases and ensures the masa dough takes the shape of the mold. Second, because there is less moisture in the dough, a shorter dwell time is required to cook the food substrate. Prior art masa-based dough recipes typically do not contain added starch. By adding starches, less corn masa is required. Corn masa has a lower propensity than starches to absorb and desorb water. As a result, when starches are used in place of corn masa, cooking time is reduced. The resulting shorter dwell time results in lower capital costs because a smaller fryer can be used and achieve the same production rate. A shorter dwell time translates into a higher oil turnover rate, meaning that more oil from the fryer is removed by the chips in the same amount of time. As a result, oil quality is preserved longer resulting in a lower oil turnover time. A lower oil turnover time increases oil quality. Third, because oil replaces moisture when the masa dough is fried, a lower moisture dough requires less oil per cooked pre-form, further reducing the amount of oil required.

FIG. 4 is a flow chart representation of one embodiment of the invention. It depicts the process used to make the novel masa dough. Dry masa 410 and pre-hydration water 420 are mixed together for approximately five to about twenty minutes in a low shear mixer to make a pre-hydrated masa 430. Any low shear mixer known to those skilled in the art can be used. For example, either a hand mixer or a mixer that can operate at about 60 revolutions per minute can be used. In one embodiment, a high shear mixer, for example, can be used. The objective is to introduce water to most of the dry masa 410. Because corn masa is not very hygroscopic, it does not easily absorb water. The mixing of water 420 and dry masa 410 facilitates the starch within the masa to absorb water. In addition, it is not necessary for the mixing to take place over the entire twenty-minute period, however the dry masa 410 is preferably pre-hydrated with the water 420 for at least twenty minutes total. Because pre-gelatinized starches are so much more hygroscopic than dry masa, the dry masa must be pre-hydrated without the starches and other minor ingredients 440 to ensure the masa is properly pre-hydrated 430. If the masa is not pre-hydrated before adding the pre-gelatinized starch, any water added is first absorbed by the starch and uneven hydration in the overall mixture results. After the masa has been pre-hydrated 430 it can be mixed with the starches and other minor ingredients 440 in a low or high shear mixer for about thirty seconds to make a flour composition 450. In one embodiment, additional water 460 can then be added and all the ingredients are aerated by a high shear mixer with blades operating at 1800 revolutions per minute for about one to about eight minutes to make a masa dough 470. For the high shear mixer, a vertical chopping mixer model #3992 available from Stephan Machinery Corporation from Columbus, Ohio having a 44E blade configuration can be used. As those skilled in the art are well aware, blade configuration, mixing time, blade speed rotation, total shear, and/or mechanical energy input can be manipulated and yet produce similar dough density, uniform moisture distribution, air entrainment, and particle size reduction results. The above-specified high shear mixing speed time, and mixer are shown for purposes of illustration and not limitation.

Following aeration in the high shear mixer, the density of the masa dough 470 has been found to range from about 0.54 to about 0.57 grams per cubic centimeter, which is nearly half the density of prior art masa dough. In an alternative embodiment, the dough is aerated by injecting a gas or a leavening agent into the dough. This masa dough 470 may then be sheeted, cut and routed to the single mold form fryer. Following compression at the sheeting step, the raw preform aerated in a high shear mixer has been found to have a density range from about 1.50 to about 1.75 grams per cubic centimeter. Surprisingly, this raw perform density is higher than a prior art masa pre-form which has a density of between about 1.30 and 1.40 grams per cubic centimeter, yet the prior art dough has less buoyancy than the dough of the present invention.

Referring to FIGS. 2 and 3, it is important to note that the masa dough pre-forms do not necessarily have to be less dense than the oil 151 in order to remain against the molds 325 of the top conveyor 120. Thus, while it is true that heavier-than-oil preforms can sink in stagnant oil, gases evolved from the pre-form 318 during cooking provide an upward force or buoyancy driving force against the molds 325. This upward force keeps the pre-forms 318 firmly seated against the top conveyor molds 325. Then, as moisture or water within the dough is replaced with oil as the pre-form is fried, the pre-form becomes less dense and becomes more buoyant than it was as a raw pre-form.

The aeration provided by, for example, the high shear mixing of the present invention results in numerous surprising benefits. First, the smaller particle size of the dough that is imparted by the high shear mixing helps impart more uniform water distribution. In prior art processes, which did not employ a single mold form fryer, water distribution was not a problem because masa-based doughs were not used in single mold form fryers to make tortilla chips. With a single mold form fryer, however, it is highly desirable to have a more constant moisture release as the chip moves through and is cooked by the oil. As discussed previously, when the chip enters the hot oil some of the moisture in the chip may be converted to steam. This steam gets trapped in the chip and increases chip buoyancy helping the chip to mate with the mold. As the steam then dissipates out of the pre-form, some buoyancy is lost, some elasticity of the chip is lost as the moisture is replaced by oil, and the pre-form may not have the requisite driving buoyancy force to cause the pre-form to bend and to take the shape of the mold. If the moisture is released at a more constant rate, however, steam leaving the pre-form is replaced by steam being produced by the substrate. This results in a more constant buoyancy driving force as the chip travels through the oil pan while mated to the mold mounted to the top conveyor.

While the mixer can impact dough density, one factor driving improved buoyancy is not necessarily the density of the raw chip (dough) alone, but rather the process of mixing and the way high shear mixing impacts the structure of the raw chip. Without being bound by theory, it is believed that during the high shear mixing of dough, nuclei are created that allows air entrainment. Nuclei comprise air cells created by nucleation process that results from high shear mixing. The air cells can comprise air and/or water entrapped with a film formed by other cellular material. The number of nuclei created will depend on the mixer type, blade configuration and the dough formulation, including added starch components. Increasing the amount of mixing shear should increase nuclei formation since this process results in the rupture of more gelatinized starch granules, releasing more amylose and water from the enclosed starch granules into the intercellular areas where nuclei are formed. The additional amylose then provides additional film-forming material, which can then be used to enclose more of these air cells. The high shear mixing also helps incorporate more air into these air cells, again speeding the nucleation process by providing the air which can then be enclosed. As defined herein, free starch is amylose released during high shear mixing of the pre-hydrated masa. In an alternative embodiment, free starch can partially or fully preclude the requirement of an added starch.

The nuclei are important since they tend to expand more during the frying process due to the enclosed moisture and/or air. The nuclei expansion during frying lowers chip's density and increases the chip's overall buoyancy. It is important to also recognize the effect of evaporation during the frying process. Part of the water that is evaporated is held within the nuclei and part is held within the intact starch granules and other areas. The higher the number of nuclei present in the raw chip (dough) translates into a higher percentage of the raw chip's (dough) total water that is held within the nuclei areas. The water in the nuclei is released at a more consistent rate, helping with continuous buoyancy until the chip is fried to a lower moisture content and has achieved a buoyant density.

The sheeting process can degas the air cells within the dough. This explains why the pre-sheeted dough is less dense than the sheeted dough. However, the sheeting process does not fully destroy the nuclei. Therefore, the nuclei can still contribute to the dough buoyancy. Addition of pre-gelatinized starches can also contribute to the consistent release of water to the surface and increased buoyancy.

It is also theorized that the high shear mixing makes a smaller particle size of the dough that results in greater uniformity of water distribution within the dough making the water release more constant over time. More uniform water distribution provides for dough machineability and sheet integrity with a lower moisture content. Thus, the dough is easily sheeted and the regrind is easily recyclable. In addition, the texture of the dough of the present invention is comparable to the texture of chips made from prior art doughs. Thus, undesirable grittiness and tooth packing is not a problem. Further, the high shear mixing results in a lower dough density, more uniform water distribution, particle size reduction, nuclei formation and greater air entrainment within the dough. The combination of nuclei formation, air entrainment, and more uniform water distribution results in a synergistic effect because the steam expands the dough in areas throughout the chip, causing small, uniform blisters that emulate the texture and appearance of traditional tortilla chips after the pre-forms are fried. These small blisters also increase the overall volume of the pre-form, further decreasing the density and increasing the buoyancy driving force. Absent the high shear mixing, moisture pockets within the dough expand causing undesirably large blisters, which complicates stacking of the fried chips. Moreover, moisture pockets often violently expand into steam and breaks through the surface film of the pre-form. Upon escape this can also undesirably cause dough fragments to migrate into the oil, negatively impacting oil quality.

In addition to mixing in the high shear mixer, other modifications can be made to facilitate air entrainment within the dough. In one embodiment, leavening agents added to the dough aerates the dough. Leavening agents comprising an alkali metal carbonate and including, but not limited to, a hydrogen carbonate, sodium bicarbonate, sodium or potassium carbonate, and calcium carbonate can be used. Other leavening agents such as sodium aluminum phosphate can also be used. In one embodiment, the dough is aerated by injecting a gas such as air into the dough. In an alternative embodiment, a gas is injected to the dough prior to, concurrent with, or following high shear mixing of the masa dough 470.

By using the masa-based dough of the present invention, all the advantages of a single mold form fryer can be attained when there is a need to make a form fried tortilla chip. For example, one advantage of using a single mold form fryer is that the reduced volume segment within the fryer oil pan 150, as shown in FIG. 2 with no bottom conveyor helps reduce the expenditure associated with replacing oxidized oil with fresh oil. Because there is no bottom conveyor throughout the reduced volume segment within the fryer oil pan 150, there is less bottom conveyor material submerged in the oil at any time. Hence there is less opportunity for the bottom conveyors to introduce oxygen into the oil to oxidize it. This reduces the rate at which the oil becomes oxidized, as well the rate at which oxidized oil must be replaced with fresh oil. This is beneficial because oil oxidation causes the cooking oil 151 to go rancid, which in turn decreases the freshness of the product, and can reduce shelf-life. Reducing oil oxidation therefore reduces costs expended to keep both the oil 151 and the product fresh.

Because the form fryer 100 with the reduced volume segment within the fryer oil pan 150 dispenses with the need for a bottom conveyor through a portion of the fryer, less conveyor material is needed to bring pre-forms into the fryer. This means that less energy is therefore required to cool the bottom conveyor material before it receives pre-forms for transportation into the fryer. Having less bottom conveyor material also reduces the amount of necessary support machinery, such as rollers, supports, and drive shafts, which in turn reduces the likelihood of mechanical jams and malfunctions. Thus, the form fryer 100 with the reduced volume segment within the fryer oil pan 150 can increase productivity both by reducing heating and cooling costs, as well as reducing the occurrence of mechanical malfunctions.

While the invention has been particularly shown and described with reference to a preferred embodiment, it will be understood by those skilled in the art that various changes in form and detail may be made therein without departing from the spirit and scope of the invention.

1.-12. (canceled)

13. A method for making a shaped corn snack using a single mold form fryer comprising the steps of:
a) providing a masa dough that comprises less than 40% water by weight;
b) aerating said masa dough to make a buoyant masa dough;
c) sheeting and cutting said buoyant masa dough into masa dough pre-forms;
d) frying each of said masa dough pre-forms in a single mold form fryer, wherein each said masa dough pre-forms is seated by a buoyancy driving force against a top conveyor mold.

14. The method of claim 13 wherein said buoyant masa dough comprises a density of between about 0.54 g/cc to about 0.57 g/cc prior to step c).

15. The method of claim 13 wherein said buoyant masa dough comprises a density of between about 1.50 g/cc and about 1.75 g/cc after step c).

16. The method of claim 1 wherein said masa dough at step a) consists of mixing dry masa and water to make a pre-hydrated masa prior to adding minor ingredients.
